(19) United States
(12) Patent Application Publication
(10) Pub. No.: US 2026/0088496 A1
(43) Pub. Date: Mar. 26, 2026

(54) FLEXIBLE DIRECTIONAL FREQUENCY MULTIPLEXING FOR MULTI-USER RF NETWORKS

(71) Applicant: The Regents of the University of California, Oakland, CA (US)

(72) Inventors: Ish Kumar Jain, San Diego, CA (US); Rohith Reddy Vennam, La Jolla, CA (US); Raghav Subbaraman, San Diego, CA (US); Dinesh Bharadia, San Diego, CA (US)

(21) Appl. No.: 19/109,686

(22) PCT Filed: Sep. 8, 2023
(86) PCT No.: PCT/US2023/073734

§ 371 Date: Mar. 7, 2025

Related U.S. Application Data
(60) Provisional application No. 63/406,142, filed on Sep. 13, 2022.

(51) Int. Cl. H01Q 3/34; H01Q 3/26; H01Q 21/00; H04B 7/06

(52) U.S. Cl. CPC H01Q 3/34; H01Q 3/2682; H01Q 21/00; H04B 7/0617

(57) ABSTRACT

An antenna device includes an antenna array having a plurality of antennas. An RF structure has a component that can vary phase response over frequency through the antenna array. A controller controls the component to create frequency-direction multi-beams from the antenna array. The antenna device can be part of an RF receiver and the RF structure can include a transmission line for each of the plurality of antennas and an RF signal connection to the transmission line for each of the plurality of antennas. The component can include a programmable delay element and a programmable phase element. The controller can set a delay of each programmable delay element and a phase each of programmable phase element in real-time to create frequency-direction multi-beams from the antenna array.

### PRIORITY CLAIM AND REFERENCE TO RELATED APPLICATION

The application claims priority under 35 U.S.C. § 119 and all applicable statutes and treaties from prior U.S. provisional application Ser. No. 63/406,142, which was filed Sep. 13, 2022.

### STATEMENT OF GOVERNMENT INTEREST

This invention was made with government support under 1925767 awarded by the National Science Foundation (NSF). The government has certain rights in the invention.

### FIELD

The invention concerns wireless (RF) communications. The invention has application, for example, to 2.3 GHz for IEEE 802.1 lax bands, 5GNR (5G New Radio)) wireless communications, and higher frequency communications.

### BACKGROUND

Modern mmWave systems are problematic to scale to a large number of users because of the inflexibility in performing directional frequency multiplexing. The frequency components in the mmWave signal are beamformed to one direction via pencil beams and cannot be simultaneously streamed to other user directions. Generally, these conventional transceivers support multiple directions in different time slots, but they can't simultaneously (in one-time slot).

Conventional mmWave networks suffer from low effective bandwidth usage mainly due to an inefficient analog front-end radio architecture. Traditional mmWave radio uses a phased array which creates directional beams to provide range and coverage in challenging high-attenuation environments. The directional beams are localized only in the angular direction but spread out over the entire bandwidth. A phased array base station radio is therefore only efficient when one angular direction has enough demand for the control and data traffic to fill the entire bandwidth (400 MHz bandwidth in 5GNR.

In practice, the bandwidth demand in one beam direction is often lower than the system bandwidth, leading to low effective bandwidth usage. For instance, as a part of the initial access procedure in 5GNR, the radio transmits a control message in different directions sequentially to locate a new user. These control messages require only 7% bandwidth towards a beam direction, but the remaining 93% resources go unused if there are no active users in that direction. Power consumption increases with bandwidth, antenna array size, and frequency using conventional techniques.

Analog architectures have been designed to improve effective bandwidth usage in MmWave. True-time delay arrays for mmWave are one example. See, Ruifu Li, et al., “Rainbow-link: Beamalignment-free and grant-free mmw multiple access using true-timedelay array,” IEEE fournal on Selected Areas in Communications, 2022; Han Yanet al., “Wideband millimeterwave beam training with true-time-delay array architecture,” 2019 53rd Asilomar Conference on Signals, Systems, and Computers, pages 1447-1452. IEEE; Veljko Boljanovic et al., “Fast beam training with true-time-delay arrays in wideband millimeter-wave systems,” IEEE Transactions on Circuits and Systems I: Regular Papers, 68(4):1727-1739, 2021 2019. Leaky-wave antenna for terahertz bands represent another approach. Yasaman Ghasempour, et al. “Single-shot link discovery for terahertz wireless networks,” Nature communications, 11(1):1-6, 2020.

These architectures provide an option to steer different frequency bands in different directions, unlike traditional phased arrays where all frequency bands go in one fixed direction. Their beam response looks like a rainbow or prism structure, mainly used for single-shot direction estimation using large bandwidth. These architectures are incapable of flexible simultaneous beams in desired directions and bandwidths, and waste bandwidth and beam power with the wide beam response.

### SUMMARY OF THE INVENTION

A preferred embodiment provides an antenna device that includes an antenna array having a plurality of antennas. An RF structure has a component that can vary phase response over frequency through the antenna array. A controller controls the component to create frequency-direction multi-beams from the antenna array. The antenna device can be in an RF transceiver and that RF structure preferably includes a transmission line for each of the plurality of antennas and an RF signal connection to the transmission line for each of the plurality of antennas. The component can include a programmable delay element and a programmable phase element. The controller can set a delay of each programmable delay element and a phase each of programmable phase element in real-time to create frequency-direction multi-beams from the antenna array.

### BRIEF DESCRIPTION OF THE DRAWINGS

FIG. 1A shows a preferred delay-phased antenna array architecture with example multi-beams having programmable beam-bandwidth and beam directions and an example gain pattern;

FIG. 1B shows a preferred delay-phased antenna array architecture within a frontend for a transceiver;

FIG. 2A shows a desired frequency-space (F−S) image for two users;

FIG. 2B shows specific Frequency-Space (F-S) signature images that illustrate how a preferred controller and antenna array can create a desired frequency-space image with two beams;

FIG. 2C shows a created frequency-space image for two users by a controller and a example preferred eight element delay-phased antenna array of the invention;

FIG. 2D shows phase and delay values for a delay-phased antenna array of the invention to generate the beamforming response shown in FIG. 2C;

FIG. 3A-3C show that phase response for each antenna is a step function with a variable step size that depends on the antenna index, n for a delay-phased antenna array of the invention;

FIG. 4A illustrates generalized multi-beams for multiple users and FIG. 4B illustrates phase response per antenna as a function of frequency for a delay-phased antenna array of the invention; and

FIG. 5 illustrates a preferred process of a controller of the invention to determine a weight matrix to assign delay and phase values to each antenna in a delay-phased antenna array of the invention.

### DETAILED DESCRIPTION OF THE PREFERRED EMBODIMENTS

Preferred embodiments provide a delay-phased antenna array architecture and controller that can conduct RF communications, including mmWave or other high frequencies, communications with flexible directional frequency multiplexing. A preferred delay-phased antenna array architecture and controller enable different frequency components to radiate in multiple arbitrary directions with comparably powered pencil beams. A delay-phased antenna array architecture and controller is 5G millimeter-wave (mmWave) front-end antenna architecture which is a delay-phased array with a controller that provides programmability over both beam direction and beam-bandwidth. It can create multiple beams in space such that each beam is localized in both angular direction and frequency bands. The controller uses estimates delay and phase values in real-time to allow operation of the delay-phased array at mmWave and even higher frequencies.

The present front-end architecture creates an abstraction that allows any orthogonal frequency-division multiple access (OFDMA) scheduler to operate flexibly without any fixed direction constraints. The controller and front-end antenna array of the invention enable multi-beam creation that permits flexible division of the entire bandwidth from one radio (RF) chain in two or more bands and can radiate each band in desired user directions. This reduces leakage in other directions. The beam-bandwidth and beam direction pairs can be chosen arbitrarily and configured in the controller software. Such programmable beam-bandwidth allows 5G NR radio, for example, to dedicate one set of frequency subcarriers for beam scanning control messages while other sets of subcarriers can be concurrently used for data communication. In this way, there are no interruptions for the communication channel (i.e., low latency overhead for data communication), and the entire bandwidth is utilized (i.e., high effective bandwidth usage).

Preferred systems perform flexible directional frequency multiplexing by transmitting/receiving a sub-set of contiguous frequency resources to each user irrespective of their directions until the allocated resources are used (no spectrum wastage). In other words, rather than transmitting all frequency components to one fixed direction, the controller through the antenna array creates multiple concurrent and different frequency pencil beams in different directions. Each beam carries a separate sub-set of frequency components for users in that beam direction, while other beams serve other directions with different frequency bands without compromising the beamforming gain in each direction.

Preferred systems use a programmable delay element and programmable phase element at each antenna in the array. The programmable delay element operates in complement to the phase element. The phase element provides direction steerability, and the delay element provides frequency selectivity. The controller uses them together to create frequency-direction multi-beams. The range of delay values supported is practical at mmWave frequencies. A preferred controller uses closed-form expression for the delay and phase values to generate the desired beam response in a minimal time period that does not inhibit real-time operation in the context of mmWave frequencies.

Preferred systems and methods permit packing the entire frequency band (up to 800 MHz for 5G NR and 2.3 GHz for IEEE 802.1 lax bands) with data to serve multiple users concurrently, thus reducing spectrum wastage and providing low latency to access the network. In transceiver devices that use the present invention, this can save board space, component cost, operating cost, physical weight, and heat generation. Mobile products would also see the added benefit of extended battery life for the user.

Preferred systems also provide remote sensing, and remote sensing with simultaneous communication. One or more of the concurrent pencil beams can be selected for remote sensing and other ones of the beams can be selected for communications.

Preferred embodiments of the invention will now be discussed with respect to experiments and drawings. Broader aspects of the invention will be understood by artisans in view of the general knowledge in the art and the description of the experiments that follows.

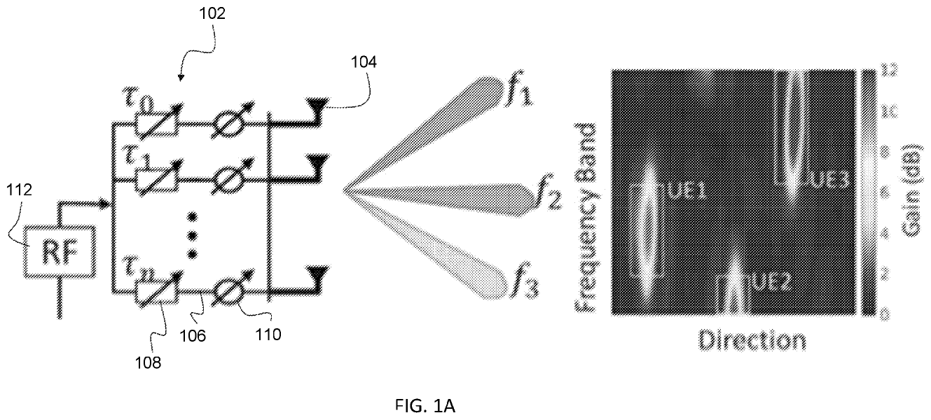

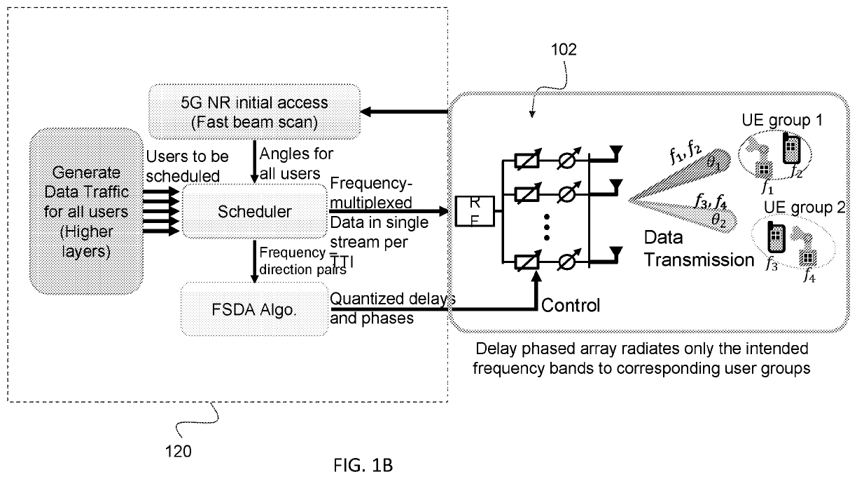

FIG. 1A shows a preferred delay-phased antenna array architecture 102. The array 102 includes a plurality of antennas 104, and each transmission line 106 to individual ones of the antennas 104 includes a programmable time delay element 108 and a programmable phase shift element 110. The array 102 can provide flexible directional frequency multiplexing.

The array includes and preferably consists of the programmable delay elements 108 and programmable phase elements 110 per antenna with a single-RF chain 112. The programmable delay elements 108 and programmable phase elements 110 can be programmed together in accordance with preferred control methods of the invention to create flexible beam responses. A controller 120 (FIG. 1B) programs delays τₙ of the programmable delay elements 108 and phase Φₙ of the programmable phase elements 110 to provide flexible directional frequency multiplexing. We define beam weights for array as:

$${w}_{d p a} ( t , n ) = {w}_{p h a s e} ( n ) {w}_{d e l a y} ( t , n ) = {e}^{j {Φ}_{n}} δ ( t - {τ}_{n} )$$

Where w_dpa(t,n) is DPA (Delayed Phase Array) weights at time t and antenna n, w_phase(n) is phase shifter weight at antenna n, w_delay(t,n) is true-time delay weight at time t and antenna n, Φn is the programmable phases for antenna index n, and in is programmable delay at antenna index n. Dependence of the weights with time leads to a dependence on frequency. Upon taking FFT, the exponential term in the weights become Φₙ−2πfτₙ, which is a function of frequency f at antenna index n. The beamforming response of this weight vector is therefore a function of both frequency and direction. The beamforming gain of an antenna array represents the power radiated by the antenna array in different directions. The expression for beamforming gain G(f, θ) for array 102 at a frequency f and direction θ is:

$$G ( f , θ ) = {\sum }_{n = 0}^{N - 1} \qquad F ( {w}_{d p a} ( t , n ) ) {e}^{- j n π s i n ( θ )}$$

where F is the Fourier transform and e^{-jnπ sin (θ)} is the standard steering vector transformation from the antenna to space (sin (θ))-domain. Essentially, the response is the sum of the individual contribution from all antennas. By equating exponential terms of array weights to that of array response, we get: Φₙ−2πfτₙ=nπ sin(θ). The variable delay causes a slope in frequency (f)−space (sin θ) plot, while the variable phase causes a constant shift along the space axis. Together, they can create an arbitrary line with a configurable slope and intercept in the frequency-space domain. The steering vector for a linear antenna array is given by

$${e}^{- j n 2 π \frac{d}{λ} s i n ( θ )} ,$$

which depends on the array geometry (antenna spacing d) and signal wavelength λ. We assume

$$d = \frac{λ}{2}$$

and approximate the steering vector as e^{-jnπ sin (θ)}.

The delay elements 106 can be implemented with variable-length transmission lines on a circuit board. Conventional true-time delay (TTD) array requires a delay range proportional to the number of antenna N, which is large for large antenna array (18.75 ns for 16 antenna array). In contrast, the delay range for the present array 102 is independent of the number of antennas. For the two-beam case, the delay range is

$$\frac{3}{2 B} ,$$

which is 3.7 ns for 400 MHz bandwidth for 5GNR; significantly less than that required by TTD arrays. The delay range increases with the number of concurrent beams, but is independent of the number of antennas, making it scalable to large arrays.

The phase elements 110 can be realized with sub-ns accuracy, as has been demonstrated in full-duplex circuits for interference cancellation. See, Nagulu, A. et al., “A full-duplex receiver with true-time-delay cancelers based on switched-capacitor-networks operating beyond the delay-bandwidth limit,” IEEE Journal of Solid-State Circuits, vol. 56, no. 5, pp. 1398-1411, 2021. Accurate delay control with 0.1 ns resolution and with 6-bit control (64 values until 6.4 ns) has been shown (See, E. Ghaderi and S. Gupta, “A four-element 500-mhz 40-mw 6-bit adcenabled time-domain spatial signal processor,” IEEE Journal of SolidState Circuits, vol. 56, no. 6, pp. 1784-1794, 2020), which satisfies the requirements the present array 102 and controller 120.

The controller 120 is configured to construct arbitrary frequency-direction response G(f, θ) via the antenna array 102 by controlling the programmable delay elements 108 and programmable phase elements 110. The control is conducted to be energy efficient and enable efficient resource utilization with low latency.

A goal of the control strategy is to transmit/receive signals in the specific frequency-direction pairs associated with each user, with minimal energy leakage in other directions and frequencies. Another goal of the control strategy is to control the amount of bandwidth assigned to each user. The control strategy provides flexibility in allocating bandwidth to each user, allowing for both narrow beams in space for higher antenna gain and wide beams in frequency to support high-demand users.

Consider the two users located at −θ₀ and θ₀ respectively, and a base station including the array 102 and controller 120 provides a control to serve these two users with equal beam-bandwidth of B/2 each, where B is the total system bandwidth. To support such flexible directional-frequency multiplexing, the base station must create a frequency-direction beam response. We call such 2D beam patterns as frequency-space (F−S) images for simplicity.

In FIG. 1B receiving/scan is used to detect users before data transmission. The flexible directional-frequency multiplexing is applied to the data transmission, while the scan conducts a fast scan of angles for all users.

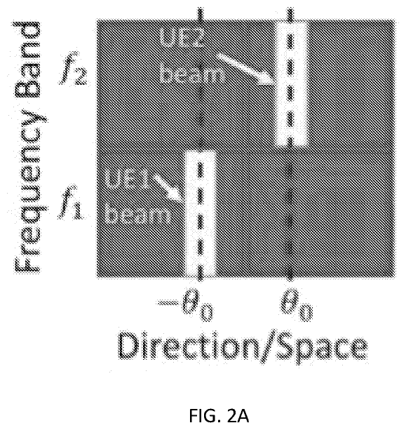

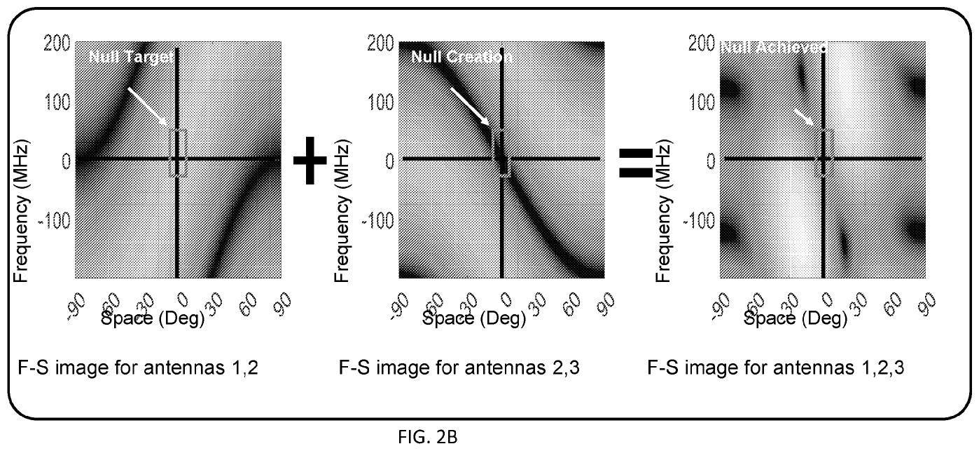

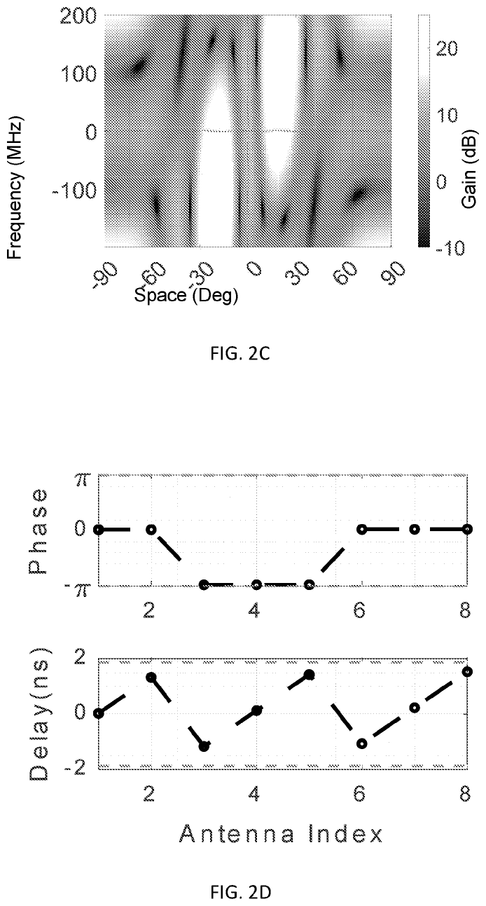

FIG. 2A shows a desired frequency-space (F−S) image for the two users. FIG. 2B shows specific Frequency-Space (F-S) signature images that illustrate how the controller 120 can use the array 102 to create a desired frequency-space image with two beams at −20° and 20°. The first beam occupies a frequency band in [−200,0] MHz and the second beam occupies a frequency band of (0,200] MHz. The controller 120 can use the array 102 (with an example number of antennas being 8) to create the desired image in FIG. 2C using delay and phase values in FIG. 2D.

One preferred control that the controller can use if very fast, has sufficient accuracy and is defined by a simple closed-form expression for the set of delays τₙ and phases Φₙ for each antenna that would generate the above beamforming response:

$${τ}_{n} = ( \frac{3}{2 B} n sin ( {θ}_{0} ) + \frac{3}{4 B} ) mod \frac{3}{2 B} {Φ}_{n} = round ( n sin ( {θ}_{0} ) ) π mod 2 π$$

In the expression, B is system bandwidth and two beams are at +theta_0 and −theta_0, respectively in this example This expression can be generalized for any number of beams and antennas in the array 102. The delay values are bounded within a range of

$$\frac{3}{2 B}$$

independent of the number of antennas. Within this range, the delay values will monotonically increase or decrease with antenna index n, but for large n, the delay wraps around with this range factor. The delay is bounded by 3/2B with the present antenna array 102 and controller 120. So as n increases, the delay also increases, but when it reaches 3/2B, it doesn't increase further. This permits the number of antenna elements in the array to increase independently of the delay, while the delay is still bounded between 0 to 3/2B. This allows for a smaller range of delay values in the hardware independent of the number of antennas. This also permits shorter length transmission line on a PCB or IC to form the delay element. This delay element can be designed once and reused to create any small or large array without redesigning the element for a specific array size.

Theorem 1−(2-beam case) We provide a derivation along with our high-level intuition on obtaining a closed-form expression for the delay and phase values. We will first formulate the objective function as an NP-hard problem and then provide an alternate optimization strategy as a set of linear equations that best approximates the solution. We first define the beamforming gain function as a function of frequency f and direction θ and then look for maximizing this function at the desired frequency-direction pairs. The beamforming gain is given by:

$$G ( f , θ ) = {\sum }_{n = 0}^{N - 1} {e}^{j {Φ}_{n} + j 2 π f {τ}_{n}} {e}^{- jn π sin ( θ )}$$

The objective is to maximize the beamforming gain ∥G(f, θ)∥² at desired beam-bandwidth at given directions ±θ₀ as follows:

$${max}_{{τ}_{n} , {Φ}_{n}} {‖ G ( f , θ ) ‖}^{2} s . t . θ = \{ - {θ}_{0} f ∈ [ \frac{- B}{2} , 0 ) {θ}_{0} f ∈ [ 0 , \frac{B}{2} ]$$

Direction and frequency have a non-linear relationship in the constraints. Specifically, the direction θ is a non-linear step function of frequency f, with a jump at frequency f=0. It jumps from the value −θ₀ to +θ₀ at this frequency. Because of this non-linear dependence of direction with frequency, the underlying optimization problem is NP-hard and cannot be solved optimally. We provide insight into the problem from a different angle and formulate a near optimal optimization that can be solved to a closed-form expression.

To simplify the above optimization, We define two new functions h(n, f) and Φ^{ant} (n, f) below to simplify the nonlinear constraint and re-write the optimization problem as follows:

$$\begin{matrix}\begin{matrix}{max}_{{τ}_{n} , {Φ}_{n}} ‖ {\sum }_{n = 0}^{N - 1} & {{e}^{j h ( n , f )} {e}^{- j {Φ}^{ant} ( n , f )} ‖}^{2}\end{matrix} s . t . h ( n , f ) = {Φ}_{n} + 2 π f {τ}_{n} and {Φ}^{ant} ( n , f ) \\ = \{ - n π sin ( {θ}_{0} ) f ∈ [ \frac{- B}{2} , 0 ] n π sin ( {θ}_{0} ) f ∈ ( 0 , \frac{B}{2} ]\end{matrix}$$

where h(n, f) is a function of variable phase Φₙ and delay τₙ at antenna n and the function Φ^{ant}(n, f) represents the constraints from the desired frequency-direction response. These functions help to simplify the optimization problem. Specifically, we apply triangle inequality to find an upper bound on the optimization variable and then maximize this upper bound. Triangle inequality states that the ‘norm-of sum is upper bounded by sum-of-norms’, which we can apply to our optimization as

$$‖ {\sum }_{n = 0}^{N - 1} {e}^{jh ( n , f )} {e}^{- j {Φ}^{ant} ( n , f )} ‖ \leq {\sum }_{n = 0}^{N - 1} ‖ {e}^{jh ( n , f )} {e}^{- j {Φ}^{ant} ( n , f )} ‖ = N$$

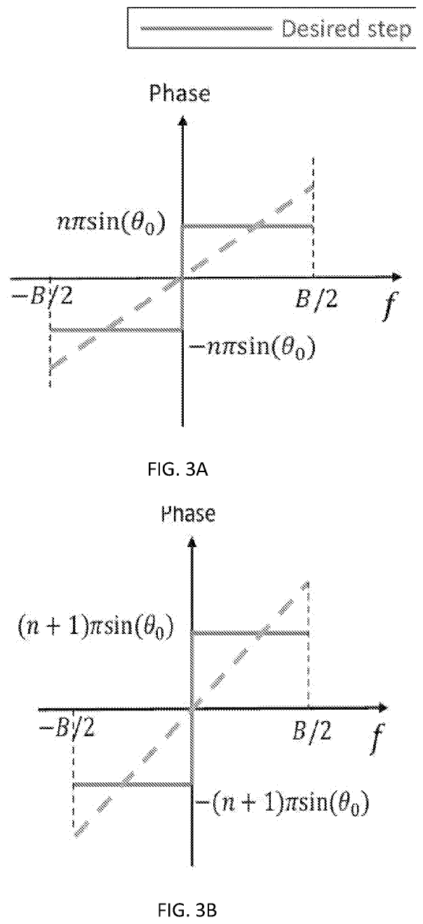

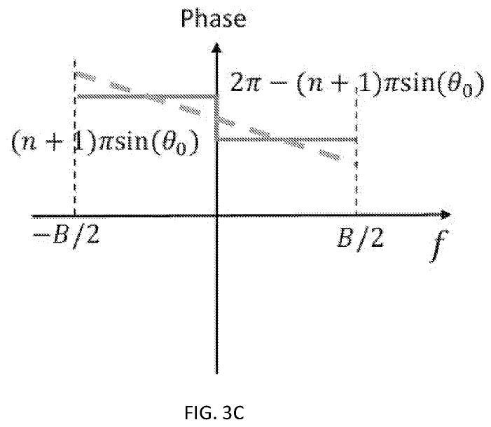

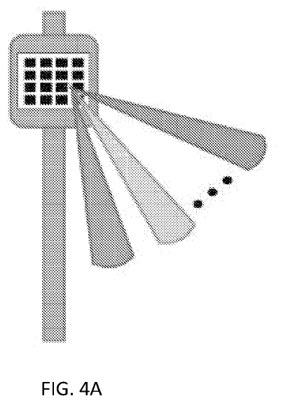

The expression is maximized if each term in the sum is unity, i.e., e^{jh(n,f)}e^{-jφ}^{^{ant}}^{(n,f)}=1, or, in other words, the two exponential terms are equal, i.e., h(n, f)=(pant (n, f) for each antenna and for each frequency. It is impossible to achieve this solution for all frequencies because the two functions h and Φ^{ant} vary differently with frequency; h is linear, while Φₐₙₜ is a step function as shown in FIG. 3A.

FIG. 3A-3C show phase response for each antenna is a step function with a variable step size that depends on the antenna index, n. In FIG. 3A, the objective is to fit a line to this step function in such a way that the error in the line fitting is minimized. FIG. 3B shows that as the antenna index increases to say, n+1, the step size of the step function also increases linearly with the antenna index. An increase in step-size leads to higher errors in line fitting. FIG. 3C shows that by reducing the step size by 2π, which will not change the desired phase response but will help to reduce the error.

The only case when the optimal results are possible is when the step size of the step function Φ^{ant} is zero, i.e., the two beams align to the same angle. In this case, the step function is reduced to a line, and optimal h can be obtained. However, this case only produces a single beam without any dependence on frequency. A natural question is how we can obtain general frequency-dependent multi-beams. We propose an optimization framework that can help to find a closed-form expression for delays and phases. Our optimization problem is formulated in a way that finds the line h that best fits the given step function Φ^{ant}. We achieve this by solving the following optimization problem on a per antenna basis:

$${min}_{{τ}_{n} , {Φ}_{n}} {‖ h ( n , f ) - {Φ}^{ant} ( n , f ) ‖}^{2}$$

Tis optimization is illustrated in FIG. 3A, where the line h(n, f) is fit over the step function Φ^{ant} (n, f). The slope of the best-fit line gives the delay value, and the y-intercept gives the phase value. In this way, one can estimate both delay and phase values by solving for the best-fit line.

However, as antenna index n increases, the error in line fitting also increases due to the linear increase in the step size with n, as shown in FIG. 3B. This could lead to high error for large antenna arrays and limit our solution to scale with antennas. To address this issue, we wrap the phase of a signal by 2π. Note that adding an integer multiple of 2π to the phase does not change the signal. This is used to strategically add a phase of multiple of 2π to a specific set of frequencies in order to minimize the error in line fitting as shown in FIG. 3C. With this insight, we redefine the step function Φ^{ant} as:

$${Φ}^{ant} ( n , f ) = \{ k 2 π - n πsin ( {θ}_{0} ) f ∈ [ \frac{- B}{2} , 0 ] n πsin ( {θ}_{0} ) f ∈ ( 0 , \frac{B}{2} ]$$

where k is a constant integer. A natural question is how to estimate this integer to minimize the error in line fitting. A preferred solution is a two-step process: solve for the delays and phases as a function of k and then find the optimal value of k to minimize the error.

To solve for per-antenna delays and phases, we form a system of linear equations. We first discretize the frequency as f=mΔf for mϵ[−M/2, M/2], where the bandwidth is B=(M+1)Δf. Note that there are M frequency bins that can be a large number, i.e., M→∞ for creating a continuous frequency axis. We then formulate a set of linear equations for each frequency term to solve for the variable delay τₙ and phase Φₙ for each antenna n. Specifically, we have the following linear equations:

$${Φ}_{n} + 2 π m Δ f {τ}_{n} = {Φ}^{ant} ( n , m Δ f ) ∀ m ∈ [ - M / 2 , M / 2 ]$$

We re-write the equations in a matrix form as follows:

$$Ax = b$$

where x is a 2×1 vector of variable phase and delay given by:

$$x = [ {Φ}_{n} 2 πΔ f {τ}_{n} ]$$

and the matrix A and vector b are constants given by:

$$A = [ 1 \frac{- M}{2} 1 \frac{- {M}^{2}}{2} + 1 ⋮ ⋮ 1 \frac{M}{2} ]$$

$$b = {[ k 2 π - ϕ … k 2 π - {ϕ}_{︸ M / 2} ϕ … {ϕ}_{︸ M / 2 + 1} ]}^{T}$$

where Φ=nπ sin (θ₀) is introduced for simplicity. Specifically, we add k2π to the first half of the frequency subcarriers, and this is reflected in the value of b.

The solution can be obtained by solving a system of linear equations as follows:

$$x = {( {A}^{T} A )}^{- 1} {A}^{T} b$$

We first solve for (A^{T}A)⁻¹ and A^{T}b separately and then multiply them together to get x:

$${A}^{T} A = [ 11 … 1 \frac{- M}{2} \frac{- M}{2} + 1 … \frac{M}{2} ] [ 1 \frac{- M}{2} 1 \frac{- {M}^{2}}{2} + 1 ⋮ ⋮ 1 \frac{M}{2} ] = [ M + 1002 {\sum }_{0}^{\frac{M}{{2}^{}}} {k}^{2} ] = [ M + 100 \frac{M ( M + 1 ) ( M + 2 )}{12} ]$$

Taking the inverse of the above 2×2 matrix, we get:

$${( {A}^{T} A )}^{- 1} = [ \frac{1}{M + 1} 00 \frac{12}{M ( M + 1 ) ( M + 2 )} ]$$

This solves for A^{T}A. Next, we obtain A^{T} b as:

$${A}^{T} b = [ 11 … 1 \frac{- M}{2} \frac{- M}{2} + 1 … \frac{M}{2} ] \times {[ k 2 π - ϕ … k 2 π - {ϕ}_{︸ M / 2} ϕ … {ϕ}_{︸ M / 2 + 1} ]}^{T} = [ \text{} ϕ + kM π ( 2 ϕ - k 2 π ) {\sum }_{1}^{M / 2} m ] = [ \text{} ϕ + kM π ( ϕ - k π ) \frac{M ( M + 2 )}{4} ]$$

This solves for A^{T}b. We now obtain the solution for unknown x as follows:

$$x = {( {A}^{T} A )}^{- 1} {A}^{T} b = [ \frac{1}{M + 1} 00 \frac{12}{M ( M + 1 ) ( M + 2 )} ] {A}^{T} b = [ \text{} {A}^{T} {b [ 1 ]}_{\frac{{A}_{1}^{T}}{M + 1}} b [ 2 ] \frac{12}{( M ( M + 1 ) ( M + 2 ) )} ]$$

Finally, using the definition of x from above, we get the solution for the per antenna phase and delay. The phase is given by x[1] and delay is given by x[2] as follows:

$${Φ}_{n} = {lim}_{M \to ∞} x [ 1 ] = {lim}_{M \to ∞} {A}^{T} b [ 1 ] \frac{1}{M + 1} = {lim}_{M \to ∞} \frac{ϕ + kM π}{M + 1} = k π$$

where the approximation is taken for a large number of frequency bins, i.e., M→28. Similarly, we get the expression for the delay:

$${τ}_{n}^{′} = \frac{x [ 2 ]}{2 πΔ f} = {A}^{T} b [ 2 ] \frac{12}{M ( M + 1 ) ( M + 2 )} \frac{1}{2 π Δ f} = ( ϕ - k π ) \frac{M ( M + 2 )}{4} \frac{12}{M ( M + 1 ) ( M + 2 )} \frac{1}{2 π Δ f} = \frac{3 ( ϕ - k π )}{2 π Δ f ( M + 1 )} = \frac{3 ( n sin ( {θ}_{0} )}{2 B} - \frac{3 k}{2 B} = \frac{3}{2 B} ( n sin ( {θ}_{0} ) - k )$$

where n is the antenna index, B is bandwidth, the set of two-beam angles are +\theta_0 and −\theta_0, and the variable k is defined below. This gives a closed-form expression of delay. Note that the expression for delay and phase both depend on the unknown constant integer k. So, how do we solve for k to obtain a generalized formula for delay and phases? Out of many possible solutions, because of the presence of a random integer k, we need to choose the value of k that minimizes the error in line fitting. To solve for k, we make an observation that the step size of the step function is part of the exponential and therefore is bounded by 2π. Let's find the condition when the step size is bounded between −π and π as follows:

$$- π < ϕ - ( - ϕ + k 2 π ) \leq π ⇒ π < 2 ϕ - k 2 π \leq π ⇒ π < 2 n πsin ( {θ}_{0} ) - k 2 π \leq π ⇒ \frac{1}{2} < n sin ( {θ}_{0} ) - k \leq \frac{1}{2} ⇒ sin ( {θ}_{0} ) - \frac{1}{2} < k \leq sin ( {θ}_{0} ) + \frac{1}{2} ⇒ k = round ( n sin ( {θ}_{0} ) )$$

Since k is an integer, the only possible value of k is given by round (n sin (θ₀)). This gives us a unique solution for the

integer constant k. Putting the in the expression of phase and delay, we get the required phase:

$${Φ}_{n} = round ( n sin ( {θ}_{0} ) ) π$$

Similarly, we obtain the final expression of delay as:

$${τ}_{n}^{′} = \frac{3}{2 B} ( n sin ( {θ}_{0} ) - round ( n sin ( {θ}_{0} ) ) )$$

We notice the above expression of delay varies in the range of

$$\frac{- 3}{4 B} to \frac{3}{4 B} ,$$

resulting in a total range of

$$\frac{3}{2 B} .$$

Since negative delays are not possible to generate in a causal system, we can add a constant delay to all antennas to make delays positive. The minimum constant delay factor that we can add without compromising on the performance is

$$\frac{3}{4 B} .$$

After adding this factor and simplifying the delay expression, we get the following:

$${τ}_{n} = {τ}_{n}^{′} + \frac{3}{4 B} = \frac{3}{2 B} ( n sin ( {θ}_{0} ) - round ( n sin ( {θ}_{0} ) ) ) + \frac{3}{4 B} = ( \frac{3}{2 B} n sin ( {θ}_{0} ) + \frac{3}{4 B} ) mod \frac{3}{2 B}$$

where the last step is a simplification of the round function into a modulo function for ease of understanding and emphasizing that the range of values of delays is independent of the number of antennas. The delay range is

$$\frac{3}{2 B}$$

for two beam case which depends inverse This is how we estimate the final expression of optimal phase Φₙ and delay τₙ.

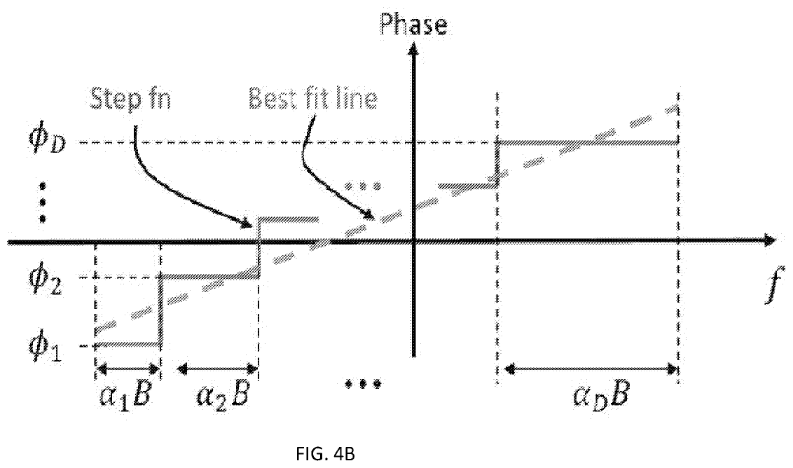

We now generalize the beamforming response to an arbitrary number of beams with arbitrary beam directions and arbitrary beam-bandwidths as shown in FIGS. 4A and 4B.

FIG. 4A illustrates generalized multi-beams for multiple users and FIG. 4B illustrates phase response per antenna as a function of frequency. Specifically, FIGS. 4A and 4B show Generalized setting for multi-beams with an arbitrary number of beams D, beam angles, and beam-bandwidths. The beam angles contributes to φ_{d}, and the beam-bandwidth is defined as α_{d}B for system bandwidth B and fraction α_{d}<1 for beam index d≤D.

Notice the above expression of delay varies in the range of

$$\frac{- 3}{4 B} to \frac{3}{4 B} ,$$

resulting in a total range of

$$\frac{3}{2 B} .$$

Since negative delays are not possible to generate in a causal system, the controller 120 can add a constant delay to all antennas to make delays positive. The minimum constant delay factor that we can add without compromising on the performance is

$$\frac{3}{4 B} .$$

After adding this factor and simplifying the delay expression, we get the following:

$${τ}_{n} = {τ}_{n}^{′} + \frac{3}{4 B} = \frac{3}{2 B} ( n sin ( {θ}_{0} ) - round ( n sin ( {θ}_{0} ) ) ) + \frac{3}{4 B} = ( \frac{3}{2 B} n sin ( {θ}_{0} ) + \frac{3}{4 B} ) mod \frac{3}{2 B}$$

Theorem 2—(Generalized case): Let there are D beam directions with beam angles θ_{d} and beam-bandwidth α_{d}B for Σ_{d} α_{d}=1. We define φ_{d}=nπ sin (θ_{d}) for simplicity. The per-antenna phases and delays in realizing such a generalized beamforming response is given by:

$${Φ}_{n} = {\sum }_{d = 1}^{D} {α}_{d} ( {ϕ}_{d} + 2 {k}_{d} π )$$

$${τ}_{n} = {\sum }_{d = 1}^{D} \frac{3}{π B} ( {ϕ}_{d} + 2 π {k}_{d} ) {α}_{d} ( {\sum }_{l = 1}^{d} 2 {α}_{l} - {α}_{d} - 1 )$$

where,

$${ϕ}_{d} = n π sin ( {θ}_{d} )$$

and the constant integer k_{d} for beam d and antenna n is:

$${k}_{d} = \{ 0 d = 1 {k}_{d - 1} + round ( \frac{n sin ( {θ}_{d - 1} ) - n sin ( {θ}_{d} )}{2} ) d \geq 2$$

Proof of Corollary 1 We prove the corollary for the two beam case by putting the number of beams D=2 in the generalized expressions and further simplify them with α₁=α and α₂=1−α. Also, note that k₁=0, by definition. We now simplify the phase as follows:

$${Φ}_{n} = {α}_{1} ( {ϕ}_{1} + 2 {k}_{1} π ) + {α}_{2} ( {ϕ}_{2} + 2 {k}_{2} π ) = α {ϕ}_{1} + ( 1 - α ) ( {ϕ}_{2} + 2 {k}_{2} π )$$

and delay

$${τ}_{n} = \frac{3}{π B} [ ( {ϕ}_{1} + 2 π {k}_{1} ) {α}_{1} ( {α}_{1} - 1 ) + ( {ϕ}_{2} + 2 π {k}_{2} ) {α}_{2} ( 2 {α}_{1} + {α}_{2} - 1 ) ] = \frac{3}{π B} [ ( {ϕ}_{1} ) α ( α - 1 ) + ( {ϕ}_{2} + 2 π {k}_{2} ) ( 1 - α ) ( α ) ] = \frac{3}{π B} [ ( - {ϕ}_{1} + {ϕ}_{2} + 2 π {k}_{2} ) α ( 1 - α ) ]$$

This proves the corollary.

We will now verify the delays and phases for the special case of equal beam-bandwidth, i.e., α=½ and symmetric angles, i.e., φ₁=−nπ sin (θ₀) and φ₂=nπ sin (θ₀). In this case, we get k₂=−round (n sin (θ₀)) and a simplified phase as:

$${Φ}_{n} = α {ϕ}_{1} + ( 1 - α ) ( {ϕ}_{2} + 2 {k}_{2} π ) = {ϕ}_{1} / 2 + {ϕ}_{2} / 2 + {k}_{2} π = {k}_{2} π = - round ( n sin ( {θ}_{0} ) ) π = round ( n sin ( {θ}_{0} ) ) π$$

which is an integer multiple of w, where the integer multiple is given by round (n sin (θ₀)). We now get delay expression as:

$${τ}_{n} = \frac{3}{π B} [ ( - {ϕ}_{1} + {ϕ}_{2} + 2 π {k}_{2} ) α ( 1 - α ) ] = \frac{3}{π B} [ ( n πsin ( {θ}_{0} ) + n πsi n ( {θ}_{0} ) + 2 π {k}_{2} ) α ( 1 - α ) ] = \frac{3}{B} [ ( 2 n sin ( {θ}_{0} ) + 2 {k}_{2} ) α ( 1 - α ) ] = \frac{3}{2 B} ( n sin ( {θ}_{0} ) + {k}_{2} ) = \frac{3}{2 B} ( n sin ( {θ}_{0} ) - round ( n sin ( {θ}_{0} ) ) )$$

This delay expression is the same as what we have derived for the simple 2-beam case. This validates the generalized multi-beam expressions for two beams. We now prove the generalized expression for an arbitrary number of beams, beam directions, and beam-bandwidths.

Proof of Theorem 2 (Generalized case) We follow the same formulation as before as a set of linear equations with a new set of constraints for the generalized case. We notice that the constant matrix A doesn't change for the generalized case, and only the constant vector b is modified. We would solve for delays and phases similar to the simple 2-beam case using pseudo-inverse (Recall x=(A^{T}A)⁻¹A^{T}b).

We start with a generic expression for vector b as:

$$b = {[ {ϕ}_{1} + {k}_{1} 2 {π…}_{\underbrace{\begin{matrix} & \end{matrix}} {α}_{1} M} {…}_{︸…} {…ϕ}_{D} + {k}_{D} 2 {π}_{︸ ( {α}_{D} ) M} ]}^{T}$$

Therefore, solution for A^{T} b is now:

$${A}^{T} b = [ 11 … 1 \frac{- M}{2} \frac{- M}{2} + 1 … \frac{M}{2} ] b$$

We first solve for phase. Since the matrix A is unchanged, we directly apply (A^{T}A)⁻¹ from the two-beam case and solve for the per-antenna phase as follows:

$${Φ}_{n} = {lim}_{M \to ∞} {A}^{T} b [ 1 ] \frac{1}{M + 1} = {lim}_{M \to ∞} \frac{{Σ}_{d = 1}^{D} {α}_{d} M ( {ϕ}_{d} + 2 {k}_{d} π )}{M + 1} = {\sum }_{d = 1}^{D} {α}_{a} ( {ϕ}_{a} + 2 {k}_{a} π )$$

This proves the expression of phase. We now solve for the delay in a similar way as we solved for the two-beam case as follows:

$${τ}_{n} = {lim}_{M \to ∞} {A}^{T} b [ 2 ] \frac{12}{M ( M + 1 ) ( M + 2 )} \frac{1}{2 π Δ f} = {lim}_{M \to ∞} {A}^{T} b [ 2 ] \frac{12}{M ( M + 2 )} \frac{1}{2 π B} = {lim}_{M \to ∞} [ ( {ϕ}_{1} + {k}_{1} 2 π ) ( - {\sum }_{m = 0}^{M / 2} m + {\sum }_{m = 0}^{{α}_{1} M - M / 2} m ) + ( {ϕ}_{2} + {k}_{2} 2 π ) ( - {\sum }_{m = 0}^{{α}_{1} M - M / 2} m + {\sum }_{m = 0}^{( {α}_{1} + {α}_{2} ) M - M / 2} m ) {\sum }_{l = 1}^{D} {α}_{l} M - M / 2 {\sum }_{l = 1}^{D - 1} {α}_{l} M - M / 2 … + ( {ϕ}_{D} + {k}_{D} 2 π ) ( {\sum }_{m = 0}^{{Σ}_{l = 1}} m - {\sum }_{m = 0}^{{Σ}_{l = 1}} m ) ] \times \frac{12}{M ( M + 2 )} \frac{1}{2 π B}$$

where we put the expression for B=(M+1)Δf for simplification. We can simplify the above expression since there is a M² term in the denominator, so we only collect the M² terms from the numerator and ignore other constant or linear terms. This is because we are interested in the case when the number of frequency bins is very high, i.e., lim_{M→∞}. This leads to a simplified expression as follows:

$${τ}_{n} = \frac{3}{π B} [ ( {ϕ}_{1} + {k}_{1} 2 π ) ( - {( 1 / 2 )}^{2} + {( {α}_{1} - 1 / 2 )}^{2} ) + ( {ϕ}_{2} + {k}_{2} 2 π ) ( - {( {α}_{1} - 1 / 2 )}^{2} + {( {α}_{1} + {α}_{2} - 1 / 2 )}^{2} ) … ( {ϕ}_{D} + {k}_{D} 2 π ) ( {( {\sum }_{l = 1}^{D} {α}_{l} - 1 / 2 )}^{2} - {( {\sum }_{l = 1}^{D - 1} {α}_{l} - 1 / 2 )}^{2} ) ] = \frac{3}{π B} [ ( {ϕ}_{1} + {k}_{1} 2 π ) ( {α}_{1} ( {α}_{1} - 1 ) ) + ( {ϕ}_{2} + {k}_{2} 2 π ) ( {α}_{2} ( 2 {α}_{1} + {α}_{2} - 1 ) ) … ( {ϕ}_{D} + {k}_{D} 2 π ) ( {α}_{D} ( {\sum }_{l = 1}^{D - 1} 2 {α}_{l} + {α}_{D} - 1 ) ) ]$$

This proves the generalized expression for phases and delays for an arbitrary number of beams, beam directions, and beam-bandwidth.

We now discuss insights into how we obtain the expression for the unknown integer constant ka to bind the error in line fitting. Recall in the two-beam system, we have seen that by strategically adding an integer multiple of 2w to the phase of one beam, we can reduce the error in line fitting without changing the actual value of the phase. This is due to the concept of phase wrapping, where adding 2w to a phase value results in the same point on the complex plane.

To generalize this insight for an arbitrary number of beams, we need to ensure that the phase difference between any then we can always add 27 to the phase of one of the two consecutive beams to make the phase difference less than T. By doing this, we can ensure that the step size doesn't grow high for a large antenna index, thus minimizing the error in line fitting. To obtain the expression for the integer constant k_{d} for each beam d, we start by fixing the phase of the first beam and then adjust the phase of the second beam with respect to the first beam and follow this process to all consecutive antennas: adjust the phase of d th beam with respect to the d−1 th beam. This ensures that no two consecutive beams have a phase difference greater than π. This results in the final expression for k_{d} above, which expresses the integer constant multiple of 2w that is added to the phase of each beam to achieve the desired bound on the phase difference. This bound on phase difference leads to a bound on the error in line fitting, resulting in an accurate line fitting for generalized multi-beam systems.

Generally, the controller 120 of the invention assigns complementary F-S images to a subset of antennas. For instance, the controller 120 can create a positive slope in F-S image using antennas 1 and 2, and then create a complementary negative slope with antenna 2 and 3 as shown in FIG. 2D. When the two responses are combined together, a frequency-space image is achieved where they combine constructively at desired user locations while creating a null (low gain) at other locations to meet a first requirement.

To meet a second requirement, the controller 120 can create such beams by choosing the number of antennas for creating a positive or negative slope. The intuition is that a higher number of antennas makes the corresponding signature image narrow in space. For instance, in FIG. 2D that three consecutive antennas (e.g. antenna 3,4,5) have increasing delays, while only two antennae (e.g. 2,3) have decreasing delays. This helps in making the positive slope in the F-S image narrow (3 antenna contribution), while the negative slope remains wide (2 antenna contribution). This effect causes beams that are narrow in space, but arbitrarily wide in frequency as shown in FIG. 2C.

### Preferred Controller Algorithm (FDSA) to Estimate Delays and Phases

To create a desired frequency-direction beam response, the base station needs to estimate the corresponding delays and phases per-antenna. Our insight is that similar to the manner in which frequency and time are related by a Fourier transform, there is a similar transform that relates space and antenna using steering matrices. There are two transforms that bridges the world of antenna weights to the desired gain pattern: time to frequency transform and antenna to space transform. Mathematically, we re-write the gain pattern to emphasize this 2D transform:

$$G ( f , θ ) = {\sum }_{k = 0}^{K - 1} {\sum }_{n = 0}^{N - 1} U ( f , k ) {w}_{dpa} ( k , n ) V ( n , θ )$$

where U(f, k) is a discrete domain Fourier transform (DFT) and the steering matrix V is defined per-element as V(n, θ)=e^{-jnπ sin (θ)}. Now since the signal is sampled only discretely with a sampling time of Ts, our original delay weight element w_{delay}(t, n) would reduce to w_{delay}(k, n)=δ(kTₛ−τₙ).

We then represent the gain pattern by a discrete frequency-space matrix G and the weights as discrete time-antenna matrix W and relate them with the following 2D transform:

$$G = UWV$$

where U is time to frequency transform matrix and V is antenna to space transform matrix. Here we formulate W as K×N matrix, where K is the number of discrete time values and N number of antennas.

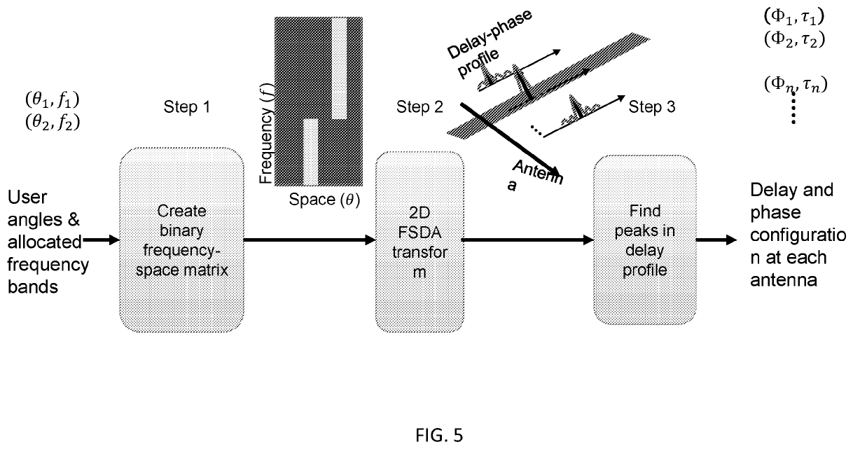

The controller 120 can follow a three-step process to estimate the weight matrix W that creates the desired frequency-space image intuitively, as shown in FIG. 5. Step 2 is the 2D transform, and the remainder is pre-processing and post-processing of inputs and outputs.

In FIG. 5, there are two inputs: Angles and desired frequency bands for each user. These two inputs are enough to represent the given frequency-space image. As a first, we create a binary frequency-space matrix that consists of 1 s at desired frequency-space locations and 0s otherwise, we denote it by G_{destired}. We then formulate the following optimization problem:

$${{Φ}_{n}}^{\hat{}} , {{τ}_{n}}^{\hat{}} = min {‖ {G}_{d e s i r e d} - UWV ‖}^{2} s . t . W ( k , n ) = {e}^{j {Φ}_{n}} δ ( k T - {τ}_{n} )$$

In this expression, G_desired is a binary matrix to represent the desired frequency-space pattern with is at high-power regions and 0s at low-power regions, U is time to frequency transform matrix and V is antenna to space transform matrix. Here we formulate W as a K×N matrix, where K is the number of discrete time values and N is the number of antennas, This optimization is a non-convex due to the non-linear terms such as exponential in phase and delta in delay. Moreover, the constraint of having a discrete set of values for delays and phases makes it NP-hard. We make an approximation by relaxing the delta constraint and letting the weights at each antenna take any variation over time. This means that the controller 120 can allow weights to take the form of a continuous profile over time at each antenna rather than a delta function which is non-zero at only one value and zero otherwise. This can be referred to as the the delay-phase profile at each antenna.

We can write an inverse transform of U and V to go from the frequency-space domain to the time antenna domain. The logic behind such formulation is that using an appropriate discrete grid along the time and space axis, we can formulate U and V as linear transforms, i.e., U^{†}U=I and VV^{†}=I for identity matrix I (Note (.)^{†} is pseudo-inverse of a matrix). Therefore, it is easy to write their inverse by simply taking the pseudo-inverse. We estimate W\hat{ } as:

$${W}^{\hat{}} = {U}^{†} {G}_{desired} {V}^{†}$$

The final step the algorithm is to extract delays an phases from W\hat{ }. Note that each column in W\hat{ } contains the delayphase profile. The controller can find the maximum peak in this profile and the index corresponding to this peak gives the delay and the max value at this peak gives the phase term. Since there is no restriction on the number of non-zero delay taps, more than one delay tap per antenna is permitted. We empirically found that the estimated delay profile has only one significant peak with high magnitude than other local peaks.

Weights Quantization: The delay and phase values obtained from the algorithm are still continuous in nature and must be discretized to be fed into the hardware. The controller can quantize both the phase and delay values with a 6-bit quantizer in software before feeding to the array. The quantized phase takes one of the 64 values in [0°, 360°) and the quantized delay varies in the range [0,6.4 ns) with an increment of 0.1 ns, in a preferred example. The run-time complexity is dominated by the 2D FFT transform on a given frequency-space image. Given the frequency, the axis is divided into M subcarriers and the space axis into D directions, the run-time complexity is O(MD(log (M)+log (D)). This is reasonable for the controller to implement in real-time, and median latency of the algorithm from testing is 0.2 ms.

While a preferred application is to a base station, The delay-phased arrays 102 and controller 120 enable a plethora of applications in communication and sensing beyond flexible directional-frequency multiplexing. For instance, the ability to create arbitrary and controllable frequency-space beams can help faster localization and tracking of multiple targets. Delay-phased arrays also enable simultaneous communication and sensing paradigms where some frequency bands are used for communication while other bands can be used for sensing. While a single RF chain is shown in FIG. 1A, multiple RF chains can be used, with each having an antenna array 102 and controller 120 such that each array can serve in a sector different from other arrays.

While detailed descriptions of implementation examples have been described above, it should be emphasized that these are only particular examples of the plurality of embodiments offered by the invention. Those skilled in the art could implement numerous variations and modifications of the disclosed embodiments that fall within the spirit or scope of this invention.

1. An antenna device, comprising:
an antenna array comprising a plurality of antennas;
an RF structure with a component that can vary phase response over frequency through the antenna array; and
a controller that controls the component to create frequency-direction multi-beams from the antenna array.

2. The antenna device of claim 1, in an RF transceiver, wherein:
the RF structure comprises a transmission line for each of the plurality of antennas and an RF signal connection to the transmission line for each of the plurality of antennas, wherein the component comprises a programmable delay element and a programmable phase element; and
the controller sets a delay of each programmable delay element and a phase each of programmable phase element in real-time to create frequency-direction multi-beams from the antenna array.

3. The RF transceiver of claim 2, wherein the controller sets a separate frequency for each of a plurality of users.

4. The RF transceiver of claim 3, wherein the controller schedules more than one user and more than one frequency in a single time slot.

5. The RF transceiver of claim 2, wherein the controller sets the delay and the phase such that each of the multi-beams have beamforming gain and nulls are created in directions other than desired directions of the frequency-direction multi-beams.

6. The RF transceiver of claim 2, wherein each delay element comprises variable length transmission lines.

7. The RF transceiver of claim 2, wherein the controller sets the delay and the phase such that specific frequency-direction pairs are associated with each user, with minimal energy leakage in other directions and frequencies.

8. The RF transceiver of claim 2, wherein the controller sets the delay and the phase according to a set of delays τₙ and phases Φₙ for each antenna via the following closed-form expression:
$${τ}_{n} = ( \frac{3}{2 B} nsin ( {θ}_{0} ) + \frac{3}{4 B} ) mod \frac{3}{2 B} {Φ}_{n} = round ( n sin ( {θ}_{0} ) ) πmod2π .$$

9. The RF transceiver of claim 8, wherein the closed-form expression sets delay values that monotonically increase or decrease with antenna index n, but for large n, the delay wraps around with this range factor and is bounded by a factor of 3/2B where B is system bandwidth.

10. The RF transceiver of claim 2, wherein the controller sets the delay and the phase according to a set of delays τ′ₙ and phases Φₙ for each antenna via the following closed-form expression:
$${τ}_{n}^{′} = \frac{x [ 2 ]}{2 π Δ f} = {A}^{T} b [ 2 ] \frac{12}{M ( M + 1 ) ( M + 2 )} \frac{1}{2 π Δ f} = ( ϕ - k π ) \frac{M ( M + 2 )}{4} \frac{12}{M ( M + 1 ) ( M + 2 )} \frac{1}{2 π Δ f} = \frac{3 ( ϕ - k π )}{2 π Δ f ( M + 1 )} = \frac{3 ( n sin ( {θ}_{0} )}{2 B} - \frac{3 k}{2 B} = \frac{3}{2 B} ( n sin ( {θ}_{0} ) - k )$$

11. The RF transceiver of claim 2, wherein the controller sets a minimum constant delay for each of the plurality of antennas.

12. The RF transceiver of claim 2, wherein the controller sets the delay and phase such that complementary frequency-space images are assigned to a subset of the plurality of antennas.

13. The RF transceiver of claim 2, wherein the controller sets the delay and phase such that frequency-space image created where the multi-beams combine constructively at user locations while creating a null at other locations.

14. The RF transceiver of claim 2, wherein the controller sets the delay such that a set of the plurality of antennas have increasing delay and another set of the plurality of antennas have decreasing delay.

15. The RF transceiver of claim 2, wherein the controller sets the delay and the phase by calculating a time to frequency transform and antenna to space transform.

16. The RF transceiver of claim 15, wherein the time to frequency transform and antenna to space transform is the following 2D transform:
$$G ( f , θ ) = {\sum }_{k = 0}^{K - 1} {\sum }_{n = 0}^{N - 1} U ( f , k ) {w}_{dpa} ( k , n ) V ( n , θ )$$
where U(f, k) is a discrete domain Fourier transform (DFT) and the steering matrix V is defined per-antenna, delay element and phase element as V(n, θ)=e^{-jπ sin (θ)}, wherein U is a time (indexed by k) to frequency (f) transform and V is an antenna (indexed by n) to space (sin(theta)) transform matrix, and w_dpa(k,n) is beamforming weights of DPA at time index k and antenna index.

17. The RF transceiver of claim 16, wherein the controller estimates the time to frequency transform and antenna to space transform by letting weights at each antenna take any variation over time, conducing a transform from the frequency-space domain to the time antenna domain, and then extracting delays and phases from the transform.

18. The RF transceiver of claim 2, wherein the controller sets a delay bounded in the range of 3/2B independent of the number of antenna, where B is bandwidth.

19. The RF transceiver of claim 2, wherein the controller estimates delay and phase by creating a frequency-space matrix, conducting a frequency-space domain conversion to a time antenna domain, and then finding maximum peaks in a created delay-phase profile.
